(19) United States
(12) Patent Application Publication
(10) Pub. No.: US 2024/0333495 A1
(43) Pub. Date: Oct. 3, 2024

(54) System and Method for Subscription-Based IOT Communication Security

(71) Applicant: Siemens Aktiengesellschaft, München (DE)

(72) Inventor: Daniel Bovensiepen, Beijing (CN)

(73) Assignee: Siemens Aktiengesellschaft, München (DE)

(21) Appl. No.: 18/695,249

(22) PCT Filed: Sep. 29, 2021
(86) PCT No.: PCT/CN2021/121937

§ 371 Date: Mar. 25, 2024

(51) Int. Cl. H04L 9/08

(52) U.S. Cl. CPC H04L 9/088; H04L 9/0861

(57) ABSTRACT

Various embodiments of the teachings include a method for subscription-based IoT communication security. An example method includes: receiving a subscription request for a service of an Industrial Internet of Things (IIoT) device from an edge device; generating a master key and key parameters for the subscription request; deploying the key parameters to the IIoT device; generating a private key with constraint based on the master key, the key parameters, Identifier (ID) information of the IIoT device, and a usage constraint parameter for subscription range, and sending the private key with constraint to the edge device; encrypting, at the device, a message based on the key parameters, the ID information of the device, and a current usage parameter, and sending an encrypted message to the edge device; and decrypting it using the private key with constraint when the current usage parameter of the message is valid for the usage constraint parameter.

### CROSS-REFERENCE TO RELATED APPLICATIONS

This application is a U.S. National Stage Application of International Application No. PCT/CN2021/121937 filed Sep. 29, 2021, which designates the United States of America, the contents of which are hereby incorporated by reference in their entirety.

### TECHNICAL FIELD

The present disclosure relates to Internet of Things (IoT) technologies. Various embodiments of the teachings herein include systems and/or methods for subscription-based Industrial Internet of Things (IIoT) communication security.

### BACKGROUND

The concept of the IoT is already several decades old by now, and some companies have started to build hardware and platforms for private or small-scale business users. The IIoT on the other side is a rather young concept derived from the IoT. Yet it is considered to be the foundation for digitialization in an industrial setting. Without connectivity, the collection and processing of data is generally impossible. Without the IIoT the digitialization of industrial scenarios can't be achieved, hence the reason that nowadays many companies try to develop and deploy IIoT solutions.

The business model of IoT companies is usually to sell the necessary hardware at a lower initial cost (which is often lower than the actual cost), and then provide corresponding services based on the subscription models. This approach enabled a fast acceptance of this new technology due to the lower initial cost. IIoT providers have started to also experiment with this business model, yet because of having a certain influence on the functions of concrete devices, subscription-based IoT models so far have lead to less success with industrial customers.

For example, in one method, during the subscription period, parts of the device logic are usually relocated to a cloud backend. This cloud backend tracks subscription state and stops the corresponding functionality in case the subscription service runs out. The enforcement of the subscription details is performed off-site and hence a permanent or semi-permanent connection to this backend is required.

An alternative method requires a locked IoT end-device which is hard-coded to only provide a certain degree of functionality for a certain period of time. Such an implementation requires that the IoT end-device needs to connect at one point to the IoT backbone server to update its service provision profile based on the given subscription/contract requirements. In case the IoT end-device is not able to connect to the backbone in a given time-period, the device might stop working all together. A device which never connects to the internet (which is common in industrial settings) is not possible to be operated in this setup.

Above mentioned restriction mean many IoT devices can't be controlled locally anymore, which is unacceptable to most industrial customers as this would imply that the functionality of an IIoT device could be stopped at any time even if the subscription was paid properly. Example for a device outage could be: due to an interruption of the internet connection; due to an outage of the vendors cloud infrastructure; or due to a software upgrade of the cloud API which doesn't support a concrete IoT firmware. Therefore, those skilled in the art are also committed to finding subscription-based IoT communication security solutions.

### SUMMARY

Some examples of the use of the teaching of the present disclosure include systems and/or methods for subscription-based IIoT communication security provided to increase the communication security of subscription-based IIoT. As an example, some embodiments include: receiving, by a subscription server, a subscription request for a service of an Industrial Internet of Things (IIoT) device from an edge device; generating, by the subscription server, a master key and key parameters for the subscription request; deploying, by the subscription server, the key parameters to the IIoT device; generating, by the subscription server, a private key with constraint based on the master key, the key parameters, Identifier (ID) information of the IIoT device and a usage constraint parameter for subscription range, and sending the private key with constraint to the edge device; encrypting, by the IIoT device, a IIoT message based on the key parameters, the ID information of the IIoT device and a current usage parameter; and sending encrypted IIoT message to the edge device; decrypting, by the edge device, the encrypted IIoT message using the private key with constraint when the current usage parameter of the encrypted IIoT message is valid for the usage constraint parameter of the private key with constraint.

In some embodiments, the method further includes: receiving, by the subscription server, a subscription extension request for the service of the IIoT device from the edge device; generating, by the subscription server, a new private key with constraint based on the master key, the key parameters, ID information of the IIoT device and a new usage constraint parameter for subscription range, and sending the new private key with constraint to the edge device; decrypting, by the edge device, the encrypted IIoT message using the new private key with constraint when the current usage parameter of the encrypted IIoT message is valid for the new usage constraint parameter of the private key with constraint.

In some embodiments, the private key with constraint is a time-limited private key, the usage constraint parameter is a time-constraint parameter, and the current usage parameter is a time stamp of current time.

In some embodiments, the private key with constraint is a usage times-limited private key, the usage constraint parameter is a usage times-constraint parameter, and the current usage parameter is a current times.

As another example, some embodiments include a system for subscription-based IIoT communication security comprising: a subscription server, to receive a subscription request for a service of an Industrial Internet of Things (IIoT) device from an edge device; generate a master key and key parameters for the subscription request; deploy the key parameters to the IIoT device; generate a private key with constraint based on the master key, the key parameters, Identifier (ID) information of the IIoT device and a usage constraint parameter for subscription range, and send the private key with constraint to the edge device; the IIoT device is to encrypt a IIoT message based on the key parameters, the ID information of the IIoT device and a current usage parameter; and send encrypted IIoT message to the edge device; and the edge device is to send the subscription request for a service of the IIoT device, receive the private key with constraint from the subscription server, and decrypt the encrypted IIoT message using the private key with constraint when the current usage parameter of the encrypted IIoT message is valid for the usage constraint parameter of the private key with constraint.

In some embodiments, the subscription server is further to receive a subscription extension request for the service of the IIoT device from the edge device; generate a new private key with constraint based on the master key, the key parameters, ID information of the IIoT device and a new usage constraint parameter for subscription range, and send the new private key with constraint to the edge device; the edge device is further to send the subscription extension request for the service of the IIoT device to the subscription server, receive the new private key with constraint from the subscription server, and decrypt the encrypted IIoT message using the new private key with constraint when the current usage parameter of the encrypted IIoT message is valid for the new usage constraint parameter of the private key with constraint.

In some embodiments, the private key with constraint is a time-limited private key, the usage constraint parameter is a time-constraint parameter, and the current usage parameter is a time stamp of current time.

In some embodiments, the private key with constraint is a usage times-limited private key, the usage constraint parameter is a usage times-constraint parameter, and the current usage parameter is a current times.

### BRIEF DESCRIPTION OF THE DRAWINGS

For a better understanding of the present disclosure, reference should be made to the Detailed Description below, in conjunction with the following drawings in which like reference numerals refer to corresponding parts throughout the figures.

FIG. 1 is a flow diagram illustrating an example method for subscription-based IIoT communication security incorporating teachings of the present disclosure.

FIG. 2 is a schematic diagram illustrating an example system for subscription-based IIoT communication security incorporating teachings of the present disclosure.

The reference numerals are as follows:

| Reference numeral | Object |
|---|---|
| S11~S15 | processes |
| 201 | subscription server |
| 202 | IIoT device |
| 203 | edge device |

### DETAILED DESCRIPTION

As described herein, an IIoT device and an edge device may run for the given subscription range completely offline without any central subscription check, namely the technical solutions has full offline capability. Besides, the IIoT device never needs to connect to the subscription server at all, thus not only the security aspect is improved but the energy efficiency, which is important in case of battery-driven device, of the device is improved. Furthermore, because the subscription server can't disturb the end-users system, the system guarantees mathematically full functionality for the given subscription period to the terminal user. In addition, the subscription can be prolonged ahead of time without affecting the currently running subscription period. DETAILED DESCRIPTION

In some embodiments, in order to increase the communication security of subscription-based IIoT, there is a subscription-based secret key service to an edge-device plus IIoT device pair. The subscription-based secret key may be generated by adopting the Identity Based Encryption (IBE) technology, but it is different from the traditional IBE technology. The various embodiments also add restrictions related to the subscription, such as time limit or usage times limit, and the private key generated based on the identity information is not sent to the owner of the identity information, but to a receiver receiving messages from the owner of the identity information.

Reference will now be made in detail to examples, which are illustrated in the accompanying drawings. In the following detailed description, numerous specific details are set forth to provide a thorough understanding of the present disclosure. Also, the figures are illustrations of an example, in which modules or procedures shown in the figures are not necessarily essential for implementing the present disclosure. In other instances, well-known methods, procedures, components, and circuits have not been described in detail so as not to unnecessarily obscure aspects of the examples.

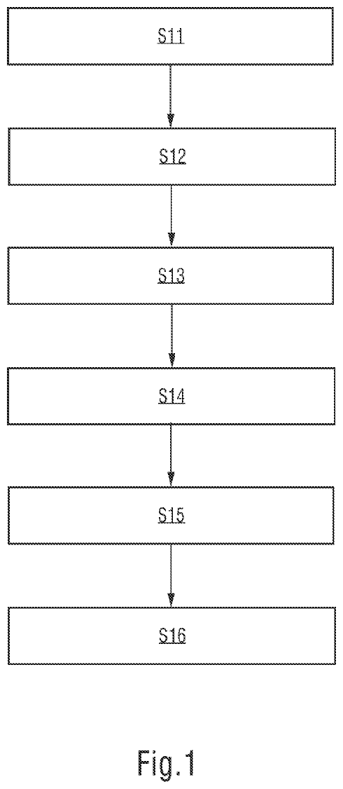

FIG. 1 is a flow diagram illustrating an example method for subscription-based IIoT communication security incorporating teachings of the present disclosure. As shown in FIG. 1, the method may include the following processes:

At block S11, a subscription server receives a subscription request for a service of an Industrial Internet of Things (IIoT) device from an edge device. When an edge device attempts to subscribe a service of a IIoT device, the edge device may send a subscription request for a service of the IIoT device to a subscription server corresponding to the IIoT device. Subscription range and identifier information of an IIoT device for indicating data of which IIoT device the edge device want to receive may be carried in the subscription request.

At block S12, the subscription server generates a master key and key parameters for the subscription request. In some embodiments, the master key and key parameters may be generated by a central authority of the subscription server according to the following formula (1):

$$P and Km := MK\_PKG ( k ) \qquad ( 1 )$$

In formula (1), Km denotes the master key which may be a private master key, P denotes the key parameters, which may include parameters M and C, wherein M is a message space, and C is a cypher text space. MK_PKG( ) may be a IBE key generator, which may be taken from the “Boneh-Franklin” or “Sakai-Kasahara” scheme. k denotes a security parameter, for example, k may be the binary length of a private key.

At block S13, the subscription server sends the key parameters to the IIoT device.

At block S14, the subscription server generates a private key with constraint based on the master key, the key parameters, Identifier (ID) information of the IIoT device and a usage constraint parameter for subscription range, and sends the private key with constraint to an edge device. The private key with constraint may be a time-limited private key or a usage times-limited private key. Correspondingly, the usage constraint parameter may be a time-constraint parameter or a usage times-constraint parameter.

In some embodiments, The private key with restriction is a subscription “license” key which is offline usable, and time-limited or usage times-limited. In an example, the time-limited private key may be generated according to the following formula (2):

$$d := USR\_PKG ( P , Km , ID , Tconstraint ) \qquad ( 2 )$$

In formula (2), d denotes time-limited private key for receiver linked to the IIoT device; P denotes the key parameters M and C; Km denotes the master private key; ID denotes identifier information of the IIoT device, for example a user ID; Tconstraint denotes the time-constraint parameter; the function USR_PKG( ) may be a IBE user key generator, which may be taken from the “Boneh-Franklin” or “Sakai-Kasahara” scheme.

At block S15, the IIoT device encrypts an IIoT message based on the key parameters, the ID information of the IIoT device and a current usage parameter, and sends encrypted IIoT message to the edge device. Corresponding to the time-constraint parameter, the current usage parameter may be a time stamp of current time. Corresponding to the usage times-constraint parameter, the current usage parameter may be a current times. For example, the IIoT device may maintain a counter, which is incremented by 1 for each IIoT message sent to the edge device.

In some embodiments, the IIoT message may be encrypted according to the following formula (3):

$$c := encrypt ( P , m , ID , Tcurrent ) \qquad ( 3 )$$

In formula (3), m denotes the IIoT message; c denotes the encrypted IIoT message, which is cypher text; P denotes the key parameters M and C; ID denotes the identifier information of the IIoT device; Tcurrent denotes time stamp of the current time relevant to subscription range; the function encrypt( ) may be a IBE encryption function, which may be taken from the “Boneh-Franklin” or “Sakai-Kasahara” scheme.

At block S16, the edge device decrypts the encrypted IIoT message using the private key with constraint when the current usage parameter of the encrypted IIoT message is valid for the usage constraint parameter of the private key with constraint.

In some embodiments, the encrypted IIoT message may be decrypted according to the following formula (4) when the time stamp of the encrypted IIoT message is valid for the time-constraint of the time-limited user key:

$$m := decrypt ( P , d , c ) \qquad ( 4 )$$

In formula (4), d denotes the time-limited private key for receiver linked to the IIoT device; c denotes the encrypted IIoT message, which is cypher text; m denotes decrypted IIoT message, which is a clear text message; the function decrypt( ) may be a IBE decryption function, which may be taken from the “Boneh-Franklin” or “Sakai-Kasahara” scheme.

The edge device will not be able to decrypt the encrypted IIoT message using the private key with constraint when the current usage parameter of the encrypted IIoT message is invalid for the usage constraint parameter of the private key with constraint. In this case, if the edge device wants to continue subscribing to the service, the edge device may send a new subscription request to the subscription server for a new private key with constraint.

In some embodiments, if the edge device wants to continue to subscribe to the service, in order to avoid the failure to decrypt the encrypted Ilor message due to the expiration of the subscription, the device can send a subscription extension request to the subscription server before the expiration of the subscription. Namely, the method may further include: the subscription server receives a subscription extension request for the service of the IIoT device from the edge device, generates a new private key with constraint based on the master key, the key parameters, ID information of the IIoT device and a new usage constraint parameter for subscription range, and sends the new private key with constraint to the edge device. After receiving the new private key with constraint, the edge device replaces previously private key with constraint with the new private key with constraint, and decrypts the encrypted IIoT message using the new private key with constraint when the current usage parameter of the encrypted IIoT message is valid for the new usage constraint parameter of the private key with constraint.

An example method for subscription-based IoT communication security incorporating teachings of the present disclosure is described in detail above, and an example system for subscription-based IoT communication security incorporating teachings of the present disclosure will be described in detail hereinafter. The methods for subscription-based IoT communication security can be implemented on systems the for subscription-based IoT communication security described herein. For details not disclosed in the embodiments of the system of the present disclosure, please refer to the corresponding description in the embodiments of the method of the present disclosure, which will not be repeated here.

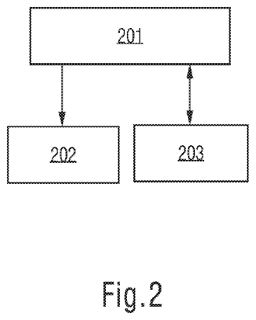

FIG. 2 is a schematic diagram illustrating an example system for subscription-based IIoT communication security incorporating teachings of the present disclosure. As shown in FIG. 2, the system may include: a subscription server 201, an IIoT device 202 and an edge device 203.

The subscription server 201is configured to receive a subscription request for a service of an IIoT device 202 from an edge device 203; generate a master key and key parameters for the subscription request; deploy the key parameters to the IIoT device 202; generate a private key with constraint based on the master key, the key parameters, Identifier (ID) information of the IIoT device and a usage constraint parameter for subscription range, and send the private key with constraint to the edge device 203.

The IIoT device 202 is configured to receive the key parameters from the subscription server, and encrypt an IIoT message based on the key parameters, ID information of the IIoT device and a current usage parameter; and send encrypted IIoT message to the edge device 203.

The edge device 203 is configured to send the subscription request for a service of the IIoT device 202, receive the private key with constraint from the subscription server 201, and decrypt the encrypted IIoT message using the private key with constraint when the current usage parameter of the encrypted IIoT message is valid for the usage constraint parameter of the private key with constraint.

In some embodiments, the subscription server 201 is further configured to receive a subscription extension request for the service of the IIoT device 202 from the edge device 203; generate a new private key with constraint based on the master key, the key parameters, ID information of the IIoT device and a new usage constraint parameter for subscription range, and send the new private key with constraint to the edge device 203.

The edge device 203 is further configured to send the subscription extension request for the service of the IIoT device 202 to the subscription server 201, receive the new private key with constraint from the subscription server 201, and decrypt the encrypted IIoT message using the new private key with constraint when the current usage parameter of the encrypted IIoT message is valid for the new usage constraint parameter of the private key with constraint.

In some embodiments, the private key with constraint may be a time-limited private key, the usage constraint parameter may be a time-constraint parameter, and the current usage parameter may be a time stamp of current time.

In some embodiments, the private key with constraint may be a usage times-limited private key, the usage constraint parameter may be a usage times-constraint parameter, and the current usage parameter may be a current times.

It can be seen from above mentioned technical solutions, the IIoT device and the edge device may run for the given subscription range completely offline without any central subscription check, namely the technical solutions has full offline capability. Besides, the IIoT device never needs to connect to the subscription server at all, thus not only the security aspect is improved but the energy efficiency, which is important in case of battery-driven device, of the device is improved. Furthermore, because the subscription server can't disturb the end-users system, the system guarantees mathematically full functionality for the given subscription period to the terminal user. In addition, the subscription can be prolonged ahead of time without affecting the currently running subscription period.

It should be understood that, as used herein, unless the context clearly supports exceptions, the singular forms “a” (“a”, “an”, “the”) are intended to include the plural forms. It should also be understood that, “and/or” used herein is intended to include any and all possible combinations of one or more of the associated listed items. The number of the embodiments of the present disclosure are only used for description, and do not represent the merits of the implementations.

The foregoing description, for purpose of explanation, has been described with reference to specific examples. However, the illustrative discussions above are not intended to be exhaustive or to limit the present disclosure to the precise forms disclosed. Many modifications and variations are possible in view of the above teachings. The examples were chosen and described in order to best explain the principles of the present disclosure and its practical applications, to thereby enable others skilled in the art to best utilize the present disclosure and various examples with various modifications as are suited to the particular use contemplated.

What is claimed is:

1. A method for subscription-based IT communication security, the method comprising:
receiving at a subscription server, a subscription request for a service of an Industrial Internet of Things (IIoT) device from an edge device;
generating a master key and key parameters for the subscription request at the subscription server;
deploying the key parameters from the subscription server to the IIoT device;
generating, by the subscription server, a private key with constraint based on the master key, the key parameters, Identifier (ID) information of the IIoT device, and a usage constraint parameter for subscription range, and sending the private key with constraint to the edge device;
encrypting, at the IIoT device, a IIoT message based on the key parameters, the ID information of the IIoT device, and a current usage parameter, and sending encrypted IIoT message to the edge device; and
decrypting, at the edge device, the encrypted IIoT message using the private key with constraint when the current usage parameter of the encrypted IIoT message is valid for the usage constraint parameter of the private key with constraint.

2. The method according to claim 1, further comprising:
receiving, at the subscription server, a subscription extension request for the service of the IIoT device from the edge device;
generating, by the subscription server, a new private key with constraint based on the master key, the key parameters, Identifier (ID) information of the IIoT device, and a new usage constraint parameter for subscription range, and sending the new private key with constraint to the edge device; and
decrypting, at the edge device, the encrypted IIoT message using the new private key with constraint when the current usage parameter of the encrypted IIoT message is valid for the new usage constraint parameter of the private key with constraint.

3. The method according to claim 1, wherein:
the private key with constraint is a time-limited private key;
the usage constraint parameter is a time-constraint parameter; and
the current usage parameter is a time stamp of current time.

4. The method according to claim 1, wherein:
the private key with constraint is a usage times-limited private key;
the usage constraint parameter is a usage times-constraint parameter; and
the current usage parameter is a current times.

5. A system for subscription-based IoT communication security, the system comprising:
a subscription server configured receive a subscription request for a service of an Industrial Internet of Things (IIoT) device from an edge device, generate a master key and key parameters for the subscription request, send the key parameters to the IIoT device, generate a private key with constraint based on the master key, the key parameters, Identifier (ID) information of the IIoT device, and a usage constraint parameter for subscription range, and deploy the private key with constraint to the edge device;
the IIoT device configured to encrypt a IloT message based on the key parameters, the ID information of the IIoT device and a current usage parameter, and send the encrypted IIoT message to the edge device; and
the edge device configured to send the subscription request for a service of the IIoT device, receive the private key with constraint from the subscription server, and decrypt the encrypted IIoT message using the private key with constraint when the current usage parameter of the encrypted IIoT message is valid for the usage constraint parameter of the private key with constraint.

6. The system according to claim 5, wherein:
subscription server is further configured to receive a subscription extension request for the service of the IIoT device from the edge device, generate a new private key with constraint based on the master key, the key parameters, ID information of the IIoT device, and a new usage constraint parameter for subscription range, and send the new private key with constraint to the edge device; and
the edge device is further configured to send the subscription extension request for the service of the IIoT device to the subscription server, receive the new private key with constraint from the subscription, and decrypt the encrypted IIoT message using the new private key with constraint when the current usage parameter of the encrypted IIoT message is valid for the new usage constraint parameter of the private key with constraint.

7. The system according to claim 5, wherein:
the private key with constraint is a time-limited private key;
the usage constraint parameter is a time-constraint parameter; and
the current usage parameter is a time stamp of current time.

8. The system according to claim 5, wherein:
the private key with constraint is a usage times-limited private key;
the usage constraint parameter is a usage times-constraint parameter; and
the current usage parameter is a current times.
